(19) United States
(12) Patent Application Publication
(10) Pub. No.: US 2018/0304393 A1
(43) Pub. Date: Oct. 25, 2018

(54) Welding Type Power Supply With Phase Shift Double Forward Converter

(71) Applicant: Illinois Tool Works Inc., Glenview, IL (US)

(72) Inventors: Bernard J. Vogel, Troy, OH (US); Quinn W. Schartner, Kaukauna, WI (US)

(73) Assignee: Illinois Tool Works Inc., Glenview, IL (US)

(21) Appl. No.: 15/956,966

(22) Filed: Apr. 19, 2018

Related U.S. Application Data
(60) Provisional application No. 62/488,439, filed on Apr. 21, 2017.

(51) Int. Cl. B23K 9/10; H02M 3/335

(52) U.S. Cl. CPC B23K 9/1012; H02M 3/3353; B23K 9/1043

(57) ABSTRACT

A method and apparatus for providing welding type power includes a phase shifted double forward converter having a first and second converter and a controller. The controller includes a pwm module that sets the pwm timing signals. The pwm module includes a phase shift module that has a leading edge adjusted output and a trailing edge adjusted output responsive to the output load. The phase shift module also includes a duty cycle offset module and/or a Dmax module that is responsive to the output load current. The pwm module includes a disabling module responsive to at least one of the output current and output voltage that disables one of the first and second converters.

### FIELD OF THE INVENTION

The present disclosure relates generally to the art of welding type power supplies and providing welding type power. More specifically, it relates to welding type power supplies and providing welding type power using a phase shifted double forward (PSDF) converter.

### BACKGROUND OF THE INVENTION

This disclosure is an improvement to the welding type power supply shown in U.S. Pat. No. 8,952,293 and U.S. Pat. No. 8,455,794, both of which are incorporated by reference and will be used as the basis for the background and description of PSDF in a welding type application. This improvement can also be applied to a PSDF used in a battery charger, such as U.S. Pat. No. 8,179,100, also incorporated by reference. Welding-type power supply, as used herein, refers to a power supply that can provide welding-type power. Welding-type power, as used herein, refers to power suitable for welding, plasma cutting, induction heating and/or hot wire welding/preheating (including laser welding and laser cladding).

Welding-type power supplies typically convert AC power to an output suitable for welding type operations. The output power is provided at an appropriate voltage and/or current level, and may be controlled and regulated according to the process requirements. Many industrial welding and cutting processes have dynamic load voltage and current requirements that cannot be met by a static power supply output. For instance, initiation of an arc, electrode characteristics, length of an active arc, operator technique, and so forth, may all contribute to transient voltage requirements. Oftentimes, these dynamic requirements, which are above the average load conditions, are of short duration (from about 1 millisecond to a few seconds) and comprise only a small part of the overall welding or cutting time. Accordingly, the power supply should be capable of providing both average and dynamic load requirements.

Single or double forward converter circuits are currently used to fulfill these dual requirements in some welding-type power supplies. The average load requirements typically determine the thermal design of the power supply circuits, dictating the size and rating of components such as transformers, heat sinks, power devices, cooling fans and so forth. However, for welding and cutting power supplies to accommodate short dynamic loads, components capable of handling the short but extreme requirements traditionally are chosen. This can result in a circuit with oversized components or a lack of efficiency when the power supply is operating at average conditions.

PSDF based welding-type power supplies can better handle both static and dynamic load requirements without some of the inefficiencies of other designs. For example, PSDF based welding-type power supplies can varying output voltage at the welding or cutting torch by manipulating the duty cycles of two forward converter circuits. Prior art PSDF welding-type power supplies found in U.S. Pat. No. 8,952,293 and U.S. Pat. No. 8,455,794 increase synchronized duty cycles in a pair of forward converter circuits in response to increasing output voltage demand. Then they change a phase shift between the duty cycles in response to further increases in output voltage demand They also accommodate the time needed for the transformer core to reset via leading edge (the start of the pulse) or lagging edge (the end of the pulse) compensation.

Phase shifting is improved by doing it in such way as to reduce the loss of control. Prior art patent U.S. Pat. No. 8,952,293 describes a “leading” and “lagging” converter (forward converter) circuit. Leading refers to operation in a phase shifted mode whereby one of the converters starts its PWM cycle before the other (ie. it leads). Lagging refers to the other converter which begins its PWM cycle after the first converter (ie. it lags). The '293 patent describes how the leading converter shifts in and out of phase while the lagging converter remains fixed in its PWM timing. The '293 patent describes taking some type of action to allow sufficient time for the forward converter transformer to fully reset as the phase shift is increasing.

These actions may include skipping a complete pulse, reducing the duty cycle of a pulse by delaying the new phase shifted leading edge, or initiating a new pulse before the core has fully reset and then reducing the pulse width by adjusting the trailing edge, to allow the core more time to reset at the end of the pulse. Skipping or reducing a pulse width of the leading converter injects a momentary disturbance in the control. This means the control loop does not get the overall duty cycle (phase shift plus leading and lagging duty cycles) that it is trying to command as required by the dynamic needs of the welding arc. This can lead to an undesirable disturbance in the welding arc, such as an arc outage or an undershoot or overshoot of the current from what the weld process control is requesting.

Initiating a new pulse before the core is fully reset may also have a turn on transient while the core demagnetizing current is still flowing. In addition, if the control loop is further increasing the phase shift, this can lead to additional consecutive cycles where the core has not fully reset and potentially lead to transformer saturation.

Prior art PSDF based welding-type power supplies operate in phase (the pulse from each converter begins and ends at the same time) the majority of the time to provide the static or average requirements of a weld process. During momentary dynamic conditions the welding arc requires higher voltage than can be met by the in phase operation of the converter circuits, so prior art PSDF based welding-type power supplies will shift out of phase (so that the pulse from one converter begins at a different time than the pulse from the other converter). Once the dynamic condition goes away, they will again operate in phase. During the time the two converters operate in phase, they split the load current. Thus each converter operates at half current. This provides for more efficient operation by reducing losses in the semiconductor switches and transformers.

However, during the time the converters operate in a phase shifted mode losses can be significantly higher because each converter is now individually carrying the full current. It is thus desirable that the two converters don't operate in a phase shifted mode for extended periods of time and/or current. The '293 patent describes means of limiting the time and/or reducing the current levels during phase shifted operation.

The '293 patent teaches a control that may drive the converter operation into a phase shifted mode during a high current condition, even though the actual arc voltage may not be higher than normal. This can happen for example while pulse GMAW (GMAW-P) welding and the weld process requires the current to be driven from a relatively low background current level (ex. 40-100 Amps) to a relatively high peak current (ex. 400-600 Amps) in a short time duration (ex. 0.5 msec to 1.0 msec). To overcome the effect of the circuit impedance and inductance, which includes the inductance of the weld cables, the PSDF shifts out of phase to provide sufficient drive voltage to raise the current level at the required di/dt rate. This condition is brought about by the weld process waveform generation, and not directly by a dynamic change in the arc voltage (which can occur while during SMAW welding).

The relationship between duty cycle and actual output voltage is not ideal, and is often described in terms of output droop. As the two converter circuits shift from in phase to out of phase operation, particularly at higher output current, the output voltage will momentarily decrease rather than increase as expected by the control. This momentary decrease in voltage appears as a non-linearity or discontinuity in the control loop. This non-linearity can lead to disturbances in the arc as the control is forced to “catch-up” and further increase the phase shift to achieve the desired output voltage. It can also allow the PSDF to get “caught” in a phase shifted mode and not naturally transition back to an in phase operation.

Prior art PSDF based welding-type power supplies typically limit the maximum switch duty cycle to between 0.4 and 0.5, to provide sufficient time for the transformer core to reset. This limit has to take into account various non ideal parameters and conditions, such as gate drive delays and voltage rise times on the switches when they turn off. It is desirable to operate the two converters of the PSDF in phase for the majority of the operating conditions, and only shift out of phase for momentary dynamic load conditions. As such it is desirable to utilize a maximum switch duty cycle (Dmax) as close to 0.5 as practical to provide the widest window of operation for in phase operation. However, the effects of gate drive delays and voltage rise times may vary depending on the switch current, which is related to the output load current. Prior art PSDF based welding-type power supplies typically select a single DMax for all load currents, in effect using a Dmax that is not as high as possible for some load currents.

When PSDF based welding-type power supplies operate at low voltage and/or low current the PWM pulse width is reduced to such a low value that it becomes difficult to consistently generate switching cycles. The control in prior art PSDF based welding-type power supplies will often cause the converters to skip some number of switching cycles followed by one or more cycles of a very small pulse width. This control can lead to increased current ripple, overshoots or undershoots, or inconsistent behavior when operating at low current and low voltage. Typically, the PWM switching behavior becomes more consistent at higher current levels and/or higher voltage levels.

Accordingly, a welding-type power supply that is capable of providing both average and dynamic load requirements using phase shifting while providing full or partial compensation of the duty cycle based on output load current, and/or modification of Dmax (max duty cycle) based on output load current, and/or improved low voltage/low current operation is desired.

### SUMMARY OF THE PRESENT INVENTION

According to a first aspect of the disclosure a method of providing welding type power includes receiving input power and pulse width modulating a first forward converter and a second forward converter such that they operate as a pulse width modulated double forward converter to provide a welding type output. First and second are used to distinguish, not to indicate an order. An output of the second forward converter is phase shifted relative to an output of the first forward converter when at least one of a duty cycle, a current command and the welding type output exceeds a threshold. The phase shifting includes adjusting a leading edge of the second forward converter and a trailing edge of the second forward converter. The first forward converter and the second forward converter are operated in phase when at least one of the duty cycle, the current command and the welding type output is in a given range (in phase operation can be less than a threshold, or between two thresholds).

According to a second aspect of the disclosure a method of providing welding type power includes receiving input power and pulse width modulating a first forward converter and a second forward converter such that they operate as a pulse width modulated double forward converter to provide a welding type output. An output of the second forward converter is phase shifted relative to an output of the first forward converter when at least one of a duty cycle, a current command and the welding type output exceeds a threshold. The pulse width modulating includes adjusting the duty cycle by an offset that is a function of at least one of the duty cycle, the current command and the welding type output. The first forward converter and the second forward converter are operated in phase when at least one of the duty cycle, the current command and the welding type output is in a given range.

According to a third aspect of the disclosure a method of providing welding type power includes receiving input power and pulse width modulating a first forward converter and a second forward converter such that they operate as a pulse width modulated double forward converter to provide a welding type output. An output of the second forward converter is phase shifted relative to an output of the first forward converter when at least one of a duty cycle, a current command and the welding type output exceeds a threshold. The threshold is adjusted in response to at least one of the duty cycle, the current command and the welding type output. The first forward converter and the second forward converter are operated in phase when at least one of the duty cycle, the current command and the welding type output is in a given range.

According to a fourth aspect of the disclosure a method of providing welding type power includes receiving input power and pulse width modulating a first forward converter and a second forward converter such that they operate as a pulse width modulated double forward converter to provide a welding type output. An output of the second forward converter is phase shifted relative to an output of the first forward converter when at least one of a duty cycle, a current command and the welding type output exceeds a threshold. The first forward converter and the second forward converter are operated in phase when at least one of the duty cycle, the current command and the welding type output is in a given range. One converter, or alternately both converters, are disabled when at least one of the duty cycle, the current command and the welding type output is less than a second threshold.

According to a fifth aspect of the disclosure a welding type power supply includes a phase shifted double forward converter having a first and second converter and a controller. The controller includes a pwm module that sets the pwm timing signals. The pwm module includes one or more of a phase shift module that has a leading edge adjusted output and a trailing edge adjusted output and the phase shift module is responsive to an output load, and/or a duty cycle offset module that provides an offset for the duty cycle based on load current, current command or duty cycle, and/or a Dmax module that sets Dmax and is responsive to output load current, and/or a disabling module responsive to at least one of the output current and output voltage and disables one of the first and second converters.

Phase shifting the output of the second forward converter relative to an output of the first forward converter when at least one of a duty cycle, a current command and the welding type output is less than a second threshold is performed, preferably in the stick mode, in one alternative.

The phase shifting also includes adjusting a trailing edge of the first forward converter in another embodiment.

The trailing edge of the first forward converter is adjusted in response to a difference between an average current of the first forward converter and an average current of the second forward converter in yet another embodiment.

The forward converters alternate as the leading (first) and lagging (second) forward converters in one alternative.

The phase shifting provides sufficient time for the transformer core to reset in another embodiment.

The phase shifting is responsive to an output load current in yet another embodiment.

The phase shifting is such that at least one of a control without discontinuities and a linear control is provided in one alternative.

The phase shifting includes adjusting a leading edge of the second forward converter and a trailing edge of the second forward converter in another embodiment.

The phase shifting includes adjusting the duty cycle by an offset that is a function of at least one of the duty cycle, the current command and the welding type output in one alternative.

The function that is used to create the duty cycle offset is at least one of a multiple of the duty cycle, a multiple of the current command, a multiple of the welding type output, a value in a look up table, responsive to a time limit, responsive to a selected weld process, and/or responsive to a state of the welding arc in various alternatives.

The phase shifting includes adjusting the threshold (at which phase shifting begins) in response to at least one of the duty cycle, the current command and the welding type output in yet another embodiment.

The threshold is adjusted between at two discreet values, more than two discreet values, a range of values and/or more than one range of values in various embodiments.

The adjusted threshold is responsive to whether or not the first forward converter and the second forward converter are in phase or out of phase in one alternative.

The threshold provides a duty cycle of more than 50% in another alternative.

One converter, or alternately both converters, are disabled when at least one of the duty cycle, the current command and the welding type output is less than a third threshold in various embodiments.

Alternately disabling the converters is performed in response to sensing a first bus voltage and sensing a second bus voltage in another embodiment.

Other principal features and advantages of will become apparent to those skilled in the art upon review of the following drawings, the detailed description and the appended claims.

### BRIEF DESCRIPTION OF THE DRAWINGS

FIG. 1 is a graph showing pulse widths for a PSDF converter with narrow pulses;

FIG. 2 is a graph showing pulse widths for a PSDF converter operating near Dmax;

FIG. 3 is a graph showing pulse widths for a PSDF converter operating out of phase;

FIG. 4 is a graph showing pulse widths for a PSDF converter operating out of phase and splitting overlap time;

FIG. 5 is a graph showing pulse widths for a PSDF converter operating with a decreasing phase shift;

FIG. 6 is a graph showing pulse widths for a PSDF converter operating with a decreasing phase shift that is shifting back into phase;

FIG. 6A is graphs showing pulse widths for a PSDF converter operating with an alternative control;

FIG. 7 is graphs showing current and voltage for in phase and phase shifted operations;

FIG. 8 is graphs showing the effect of leakage inductances;

FIG. 9 is a graph showing load line non-linearity;

FIG. 10 is a graph showing a family of load lines;

FIG. 11 is a graph showing current and voltage with full compensation;

FIG. 12 is a graph showing current and voltage with partial compensation;

FIG. 13 is a graph showing current and voltage with compensation;

FIG. 14 is a graph showing effective duty cycle;

FIG. 15 is a graph showing control for extended operating ranges;

FIG. 16 is a perspective view of an exemplary welding type power supply unit in accordance with aspects of the present disclosure;

FIG. 17 is a block diagram of the components of an exemplary welding type power supply in accordance with aspects of the present disclosure;

FIG. 18 is a circuit diagram illustrating an exemplary embodiment of the power supply comprising forward converter circuits in accordance with aspects of the present disclosure; and

FIG. 19 is a block diagram of a controller for the welding-type power supply of FIG. 16.

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present disclosure will be illustrated with reference to it should be understood at the outset that the power supply can also be implemented with other topologies and controls.

Generally, this disclosure teaches the control of a PSDF based welding-type power supply that provides one or more of improved phase shifting, full or partial compensation of the duty cycle based on output load current, modification of Dmax based on output load current and/or improved low voltage/low current operation. The control may be implemented to control prior art topologies and circuits, and using modified prior art controllers.

Phase shifting can be improved by doing it in such way as to reduce the loss of control and to achieve the overall duty cycle as required by the control, with no disturbance (meaning desired duty cycle and phase shift is achieved), and the transformer core has sufficient time during a PWM cycle to fully reset. In general, the control fixes the PWM timing of the leading converter circuit and adjusts both the leading and trailing edges of the lagging converter circuit. In one embodiments the control fixes the PWM timing of the lagging converter circuit and adjusts both the leading and trailing edges of the leading converter circuit.

Full or partial compensation of the duty cycle based on output load current can be provided to help linearize the control and/or reduce discontinuities in the control as the converters shift in and out of phase. This can reduce or eliminate the likelihood of the PSDF to get caught in a phase shifted mode. The compensation of the duty cycle term can be applied to fully linearize the control for both in phase and phase shifted mode (ie. full compensation), or alternatively in can be applied to partially compensate the phase shifted mode or the in phase mode.

The maximum duty cycle (Dmax) can be modified based on output load current to provide a wider window of operation for in phase operation. The PSDF control disclosed herein can adjust Dmax between two or more values (discrete values or a continuously adjusted value) as a function of the output load current, a current command, duty cycle, or other parameters. In addition, adjusting Dmax may be applied differently, or disabled, for in phase vs. phase shifted operation of the two converters.

Operation at low voltage and or low current can be improved by reducing pulse skipping. The control takes advantage of the additional time to overcome leakage inductance and voltage drops by disabling either the leading or lagging converter if the PWM pulse width falls below a threshold and the actual output current or commanded output current falls below a threshold. During this mode of operation normally the two converters operate in phase and share the output load current. By disabling one of the converters during this condition of operation the remaining converter carries all of the load current and therefore operates at a somewhat wider PWM pulse width to overcome its own leakage inductance as well as other voltage drops within the converter. This naturally forces the control to command a wider pulse width during these conditions and provide a wider window of operation where a consistent pulse width can be commanded.

One alternative provides that during this mode of operation the converter that is operating and the converter that is off is alternated to balance the thermal load as well as to balance the power draw from an upper DC bus and lower DC bus for a condition where the two forward converters are operating in a stacked or series arrangement on their input. This may be desirable to keep the two series bus voltages balanced. Thus, the bus voltages are sensed, and the feedback is used by the control modules. The control may alternate which converter is operating and carrying the full load current every other switching cycle or some multiple thereof. The control may also take into account the voltage balance on the two DC bus voltages in a series arrangement, and modify the sequence, to cause the converter associated with a higher bus voltage to operate for additional switching cycles relative to the converter operating from the bus voltage with a lower magnitude.

The control may further extend the low voltage and low current operation by increasing the PWM OFF time in a controlled manner once a minimum PWM duty cycle ON time has been reached. This can provide a further increase in the window of operation where a consistent pulse width can be commanded and provide a more consistent output current control behavior. This increase in PWM OFF time can have an upper limit, such that once the limit is reached the control once again begins to skip pulses as necessary to maintain a given output current and/or voltage.

Generally, different types of welding have different output needs. TIG welding generally needs low current, which makes pulse skipping useful. Stick welding dynamically needs high current very quickly. These different needs can be served using different control techniques. As discussed above, generally the two converters share the load and are in phase. However, when they need to be operated out of phase (such as at high temporary output) the converters have more droop in the output because each converter carries the full load. Compensation for the droop can be provided for by lengthening the duty cycle. One alternative provides for operating the two converters out of phase at low current to reduce ripple, which can reduce the output inductance and shorten response time. This is particularly useful for stick welding because stick welding sometimes requires a quick high output to prevent an arc outage.

The preferred embodiment of the PSDF based welding-type power supply and control thereof will be described with respect to the circuit shown in the '293 patent, and the control will be the same as that described in the '293 patent, except as otherwise discussed.

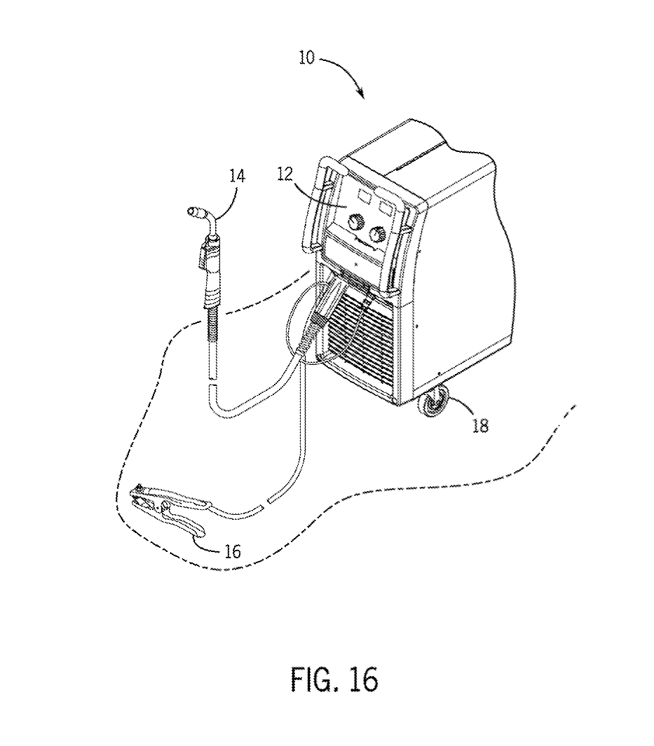

FIG. 16 illustrates an exemplary welding type power supply unit 10 which powers, controls, and provides supplies to a welding or cutting operation in accordance with aspects of the present invention. The side of the power supply unit 10 that faces the user contains a control panel 12, through which the user may control the supply of materials, such as power, gas flow, wire feed, and so forth, to a welding or cutting torch 14. A work lead clamp 16 typically connects to a workpiece to close the circuit between the torch 14, the work piece, and the supply unit 10, and to ensure proper current flow. It should be noted that in some embodiments, such as for stick welding operations, the torch 14 may be an electrode. The portability of the unit 10 depends on a set of wheels 18, which enable the user to move the power supply unit 10 to the location of the weld. Welding-type power supply unit 10 receives input power from a typical source, such as utility power, engine power, battery power, fuel cell, etc. Welding-type power supply unit 10 provides a welding type output (welding type power) across the work clamp and cutting torch.

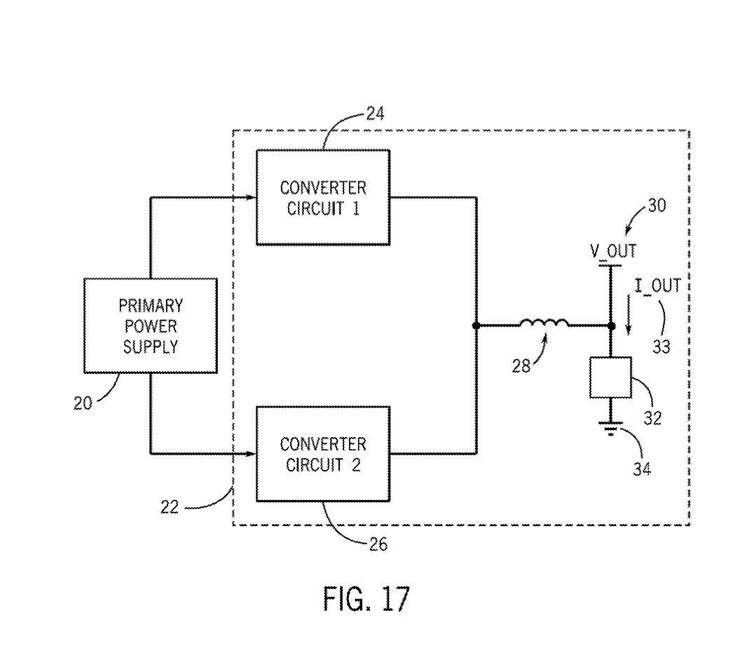

Internal components of the power supply unit 10 convert input power (from a wall outlet or other source of AC or DC voltage, such as a generator, battery or other source of power), to an output consistent with the voltage, current, and/or power, requirements of a welding or cutting arc maintained between the workpiece and the welding torch 14. FIG. 17 illustrates an exemplary block diagram of components that may be included in the welding or plasma cutting power supply unit 10. Specifically, FIG. 17 illustrates a primary power supply 20 which receives input power and outputs direct current (DC) to a power circuit 22 comprising a first converter circuit 24 and a second converter circuit 26. The converter circuits 24, 26 operate to combine their respective outputs at a single node, which feeds into a filter inductor 28 that supplies an output voltage 30 (i.e. V_out) for the welding or cutting operation. The welding or cutting arc 32 is supplied with a welding or cutting current 33 and is connected to ground 34. In one embodiment, separate inductors (one for each converter circuit) may be utilized in place of the filter inductor 28. In other embodiments, the inductor 28 may have multiple windings used to combine the outputs of the two converter circuits 24, 26.

In one embodiment, the power supply 20 may be a DC source, such as a battery. In other embodiments, the power supply 20 may be a circuit that rectifies incoming alternating current (AC), converting it to DC. In the exemplary block diagram shown in FIG. 2, each of the converter circuits 24, 26 are connected to a single primary power supply 20. In other embodiments, the circuits 24, 26 may be powered from separate power supplies. In further embodiments, the circuits 24, 26 may be connected in parallel or series to the primary power supply 20 at the capacitors 36, 56 of the converter circuits 24, 26. In the embodiment where the circuits 24, 26 are connected in series with a single primary power supply 20, each converter circuit receives half the total voltage of the primary power supply 20, which allows for the use of lower voltage components within the converter circuits 24, 26.

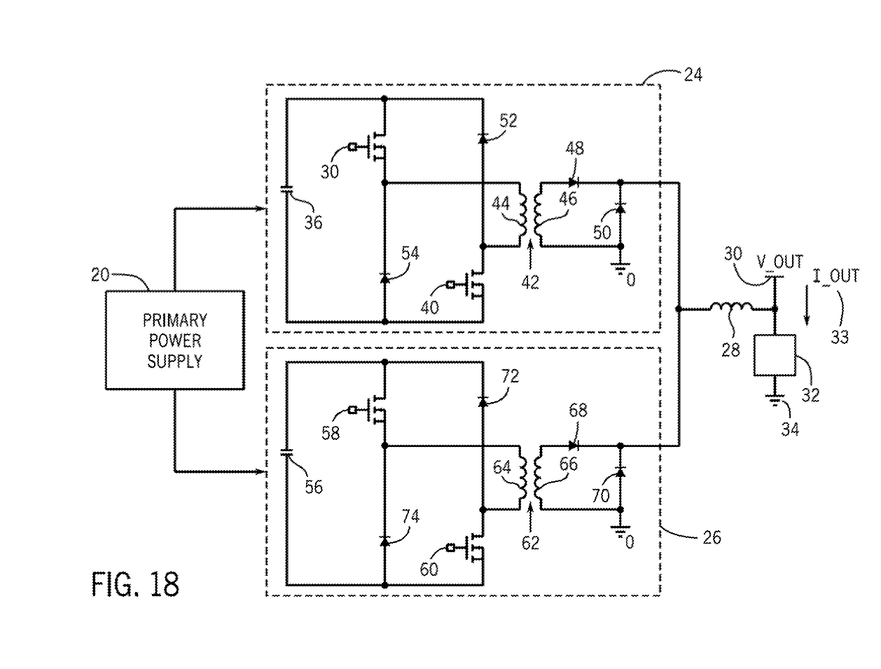

FIG. 18 is a circuit diagram illustrating one embodiment of the power circuit 22 comprising the two forward converter circuits 24, 26 in accordance with aspects of present embodiments. As previously described, the primary power supply 20 provides DC power to the first converter circuit 24 and the second converter circuit 26. In the first inverter circuit 24, a voltage is first supplied across a capacitor 36. A pair of power semiconductor switches 38, 40 then chops the DC voltage and supplies it to a transformer 42 on the side of a primary winding 44 of the transformer 42. The transformer 42 transforms the chopped primary voltage to a secondary voltage, at a level suitable for a cutting or welding arc, and supplies it to a secondary winding 46 of the transformer 42. The secondary voltage is then rectified by rectifier diodes 48, 50 and supplied to the filter inductor 28. A set of diodes 52, 54 provide a free-wheeling path for the magnetizing current stored in the transformer 42 to flow when the pair of semiconductor switches 38, 40 turn off, and thus reset the magnetic flux or energy stored in the transformer core.

Similarly, in the second inverter circuit 26, a voltage is first supplied across a capacitor 56. A pair of power semiconductor switches 58, 60 then chops the DC voltage and supplies it to a transformer 62 on the side of a primary winding 64 of the transformer 62. The transformer 62 transforms the chopped primary voltage to a secondary voltage and supplies it to a secondary winding 66 of the transformer 62. The secondary voltage is then rectified by rectifier diodes 68, 70 and supplied to the filter inductor 28. A set of diodes 72, 74 provide a free-wheeling path for the magnetizing current stored in the transformer 62 to flow when the pair of semiconductor switches 58, 60 turn off, and thus reset the magnetic flux or energy stored in the transformer core.

The combined rectified secondary voltage is supplied to the welding or cutting power supply output 30 and a welding or cutting current 32 is output from the circuits 24, 26. In other embodiments, the forward converter circuits 24, 26 may include additional components or circuits, such as snubbers, voltage clamps, resonant “lossless” snubbers or clamps, gate drive circuits, pre-charge circuits, pre-regulator circuits, and so forth. Further, as previously noted, the forward converter circuits 24, 26 may be arranged in parallel or in series in accordance with present embodiments, meaning that the capacitors 36, 56 may be connected in series or in parallel. Additionally, in further embodiments, the output of the first converter circuit 24 and the output of the second converter circuit 26 may be connected in series. In this embodiment, a single ground is configured to support both circuits 24, 26, and the output of the diodes 48, 50 of the first converter circuit 24 couples with the output of the diodes 68, 70 of the second converter circuit 26 before entering the inductor 28. A more detailed description of the circuit's operation is found in the '293 patent.

One aspect of this disclosure relates to improved phase shifting. The method fixes the PWM timing of the leading converter circuit and adjusts both the leading and trailing edges of the lagging converter circuit. The controller includes a phase shift module that has a leading edge adjusted output and a trailing edge adjusted output. One alternative fixes the PWM timing of the lagging converter circuit and adjusts both the leading and trailing edges of the leading converter circuit.

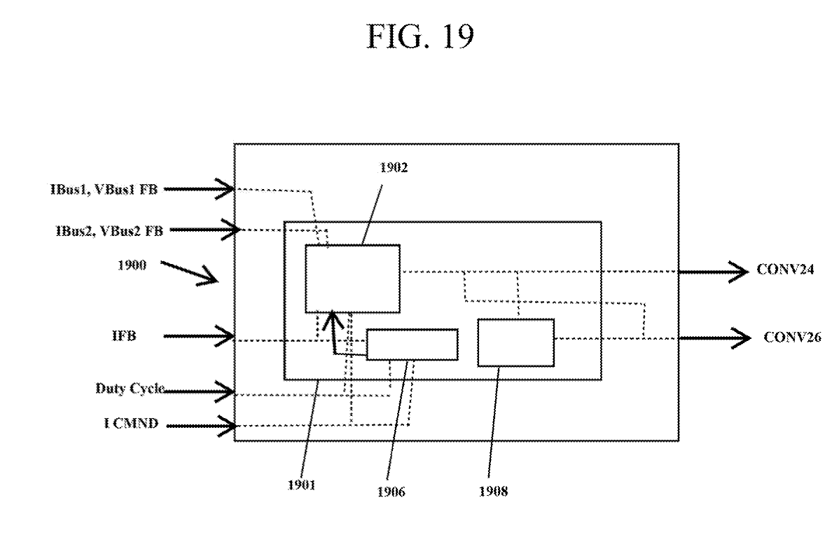

Welding type power supply 10 is controlled by a controller 1900 (FIG. 19). Controller 1900 can be consistent with prior art welding-type power supply controllers, except as set forth herein. Generally, controller 1900 controls the switching of converter 24 and 26 so that they provide a desired output. The desired output is typically determined by a user input and/or a welding program. A current command is indicative of the desired current output, and the duty cycle of the converters is adjusted to provide the desired current output. Feedback indicative of the output is used to provide closed loop control. Controller 1900 provides timing signals of the leading and trailing edges of the pulses from converters 24 and 26.

Controller 1900 includes, in the preferred embodiment, a number of control modules that implement the phase shifting and control described herein. A PWM module 1901 provides the signals to converter 24 and 26 that cause them to turn on and off. PWM module 1901 can include the logic and circuitry of prior art PWM modules, but also includes modules that help implement the control described herein. PWM module 1901 provides the on/off signals (pwm timing signals) to converters 24 and 26 in response to feedback indicative of the output (such as the output load current or output load voltage) and a command signal. The input to PWM module 1901 that receives the feedback is called an output load current input.

A phase control module 1902 (or phase shift control module), as used herein, sets the relative phase of converters 24 and 26. Phase control module 1902 can cause converters to be in phase or out of phase, as discussed below. Phase control module 1902 provides, in the preferred embodiment, a leading edge adjusted output and a trailing edge adjusted output that determine the phase shift between the converters. Phase control module 1902 receives the output load current input and provides the phase adjustments in response to the output current. A duty cycle module 1906 module determines an offset for the duty cycle and/or determines the maximum duty cycle at which phase shifting begins. When module 1906 is implemented as a duty cycle offset module is determines an offset for the duty cycle in response to the output, or the current command, and is preferably responsive to output load current. The offset be determined by DMax module 1906 as set forth below. When module 1906 is implemented as a DMax module it determines the maximum duty cycle at which phase shifting begins in response to the output, or the current command, and is preferably responsive to output load current. The threshold can be adjusted by DMax module 1906 as described below, wherein DMax varies with load current. Module 1906 provides a signal to PWM module 1904, and can be one or both of a DMax module and a duty cycle offset module. A disabling module 1908 provides a signal that disables one of converters 24 and 26 (or alternately disables them) so that at low current better control may be provided.

Controller, as used herein, refers to digital and analog circuitry, discrete or integrated circuitry, microprocessors, DSPs, FPGAs, etc., and software, hardware and firmware, located on one or more boards, used to control all or part of a welding-type system or a device such as a power supply, power source, engine or generator. Control module, as used herein, may be digital or analog, and includes hardware or software, that performs a specified control function. Phase control module, as used herein, may be digital or analog, and includes hardware or software, that controls the relative phase of two converter circuits. Pwm module, as used herein, is a module that set the pulse width of the converters, including setting the start and end times of the pulses. Duty cycle offset module, as used herein, refers to a module that determines the offset for a duty cycle in response to a commanded current, an output current, a duty cycle, or other indicators of load, such that the control is linearized or discontinuities are avoided. Dmax module, as used herein, refers to a module that determines the threshold and/or maximum duty cycle at which phase shifting will be provided. A Dmax module can be responsive to feedback or commands, and can adjust DMax based on a commanded current, an output current, a duty cycle, or other indicators of load. Disabling module, as used herein, refers to a control module that selectively disables one of two converters at any one time, and can alternately disable converters. Module, as used herein, includes software and/or hardware that cooperates to perform one or more tasks, and can include digital commands, control circuitry, power circuitry, networking hardware, etc.

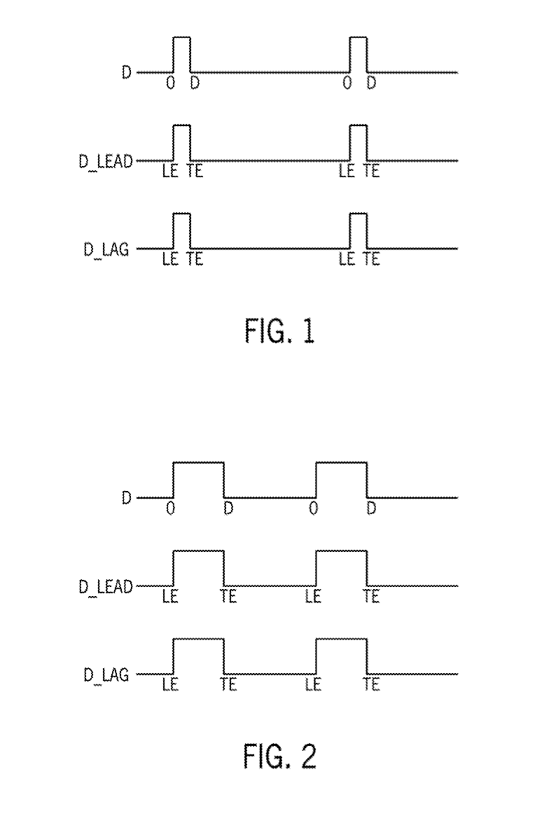

Before describing the improved phase shifting, the in-phase operation will be described. FIG. 1 shows a condition where the two forward converters are operating in phase at a relatively small PWM switch duty cycle. Duty cycle D is defined as the total or overall duty cycle as requested or commanded by the control, and is comprised of the individual converter duty cycles and the phase shift between the two PWM signals. D_LEAD and D_LAG are the respective individual duty cycles of the leading and lagging forward converter. Each has a leading edge (LE) and trailing edge (TE) which are in sync because the two converters are operating in phase.

FIG. 2 shows another set of waveforms for in phase operation but at a wider duty cycle approaching Dmax (eg. 45%). For FIGS. 1 & 2 the duty cycle for each converter begins at LE which can be defined as the start of the PWM period or at T=0. The duty cycle (or ON time) of each converter ends at TE which is the same for both D_LEAD and D_LAG for in phase operation and is therefore set to D. The equations below summarize how the duty cycles are set for in phase operation.

If D < Dmax

Dphase = 0
Dlead = D : {LE =0, TE = D}
Dlag = D : {LE =0, TE = D}

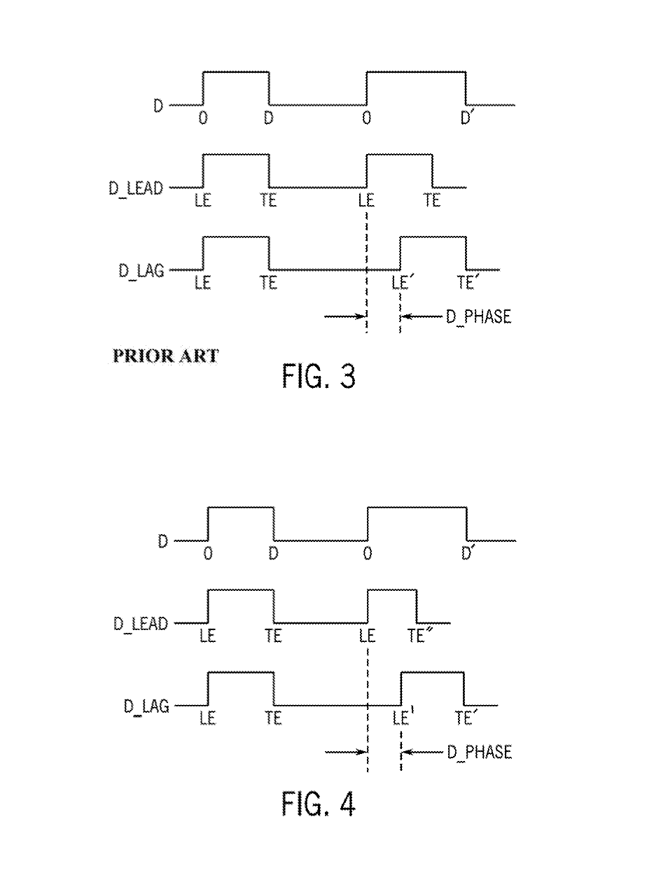

FIG. 3 shows a condition where the control is increasing the duty cycle beyond D_max. As the overall duty cycle increases from D to D′, the lagging forward converter shifts out of phase. FIG. 3 shows that as the phase shift is increasing there is no momentary reduction of the overall duty cycle. The overall duty cycle is satisfied beginning with the leading edge (LE) of D_LEAD and ending with the trailing edge (TE′) of D_LAG. D_PHASE is the required phase shift between the leading edge of D_LEAD to the leading edge of D_lag. It can also be seen from FIG. 3 that for the case of increasing phase shift there is also no reduction of the OFF time period for D_LAG, allowing sufficient time for the transformer core to fully reset. (The time period from TE to LE is greater than the previous ON time portion of LE to TE for D_LAG).

The '293 patent describes the issue with non-ideal circuit components and specifically leakage inductance whereby this leads to a mismatch in average current carried by the two converters during phase shift operation. The '293 patent describes splitting the overlap time when the two converters operate in phase shift mode to more closely balance the average currents.

The improvements below are implemented with control modules that receive current and/or voltage feedback as needed. A phase control module causes the desired shift, duration and timing of the PWM pulses.

FIG. 4 shows the modification of the duty cycles in accordance with the present disclosure to split the overlap time. The ON time of the leading converter D_LEAD has been shortened by setting the trailing edge (T″) to approximately one half of the overall duty cycle (D′). The leading edge of the lagging converter remains at LE′. The primary benefit of splitting the overlap time can be achieved by only reducing the pulse width of the leading converter, because the lagging converter will not pick up much current until the leading converter turns off. It is also possible to align the leading edge (LE′) of D_LAG with the new trailing edge (TE″) of D_LEAD, but the primary benefit can be achieved by just shortening the ON time of the leading converter.

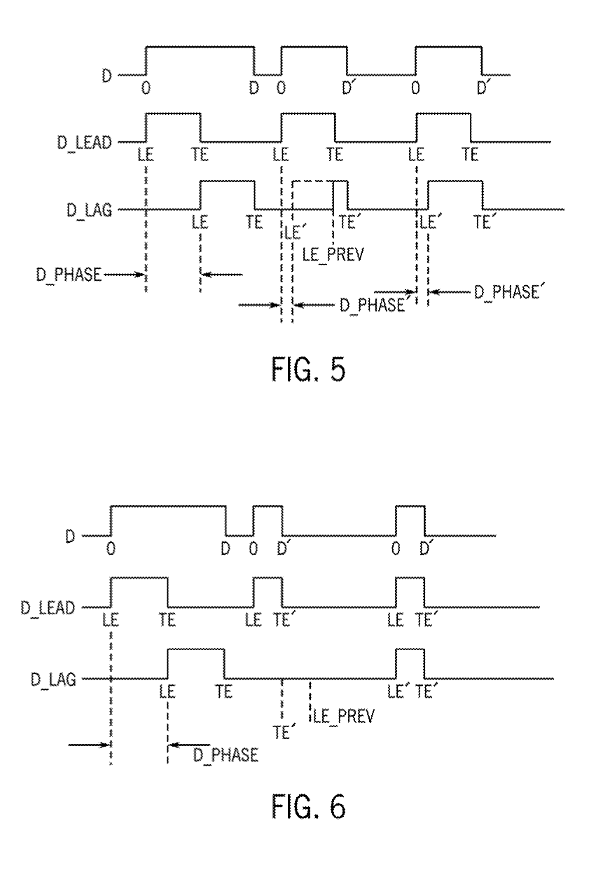

FIG. 5 shows a situation where the control is decreasing the overall duty cycle from D to D′. For this situation the two converters were operating in a phase shifted mode close to maximum phase shift (ie. Nearly fully out of phase), and the control requires a new operating point with less phase shift to satisfy the dynamic load requirements of the power supply. FIG. 5 illustrates operation without taking action to split the overlap time.

The lead converter operates with a duty cycle D_LEAD with leading and trailing edges (LE, TE) with no change as the phase shift is decreased. The lagging converter is required to reduce its phase shift with respect to the lead converter. For the initial PWM period with decreased phase shift the lag converter only shifts its trailing edge (TE′) to align with the overall required duty cycle D′ and does not change the leading edge. The overall duty cycle is satisfied beginning with the leading edge (LE) of D_LEAD and ending with the trailing edge (TE′) of D_LAG. So for both increasing and decreasing phase shift the overall duty cycle (D & D′) is fully met without skipping a pulse or reducing the pulse width of either converter in such a manner that it interferes with the control, and therefore the dynamic needs of the welding power source.

It is desired to move the leading edge to LE′. FIG. 5 illustrates that if this was done for this initial PWM period, there is not sufficient time for the lagging converter transformer to fully reset (ie. The time interval from TE to the new LE′ is less than the previous ON time). So to provide sufficient time for the core to reset the leading edge is left at the previous LE for the initial PWM period and then moved to LE′ during the subsequent PWM cycle.

It can also be seen in FIG. 5 that again there is sufficient time for the lagging converter transformer to fully reset. The OFF time (from TE′ to the new LE′) is greater than the previous ON time (from LE_PREV to TE′). So for the sequence of PWM pulses shown with decreasing phase shift, the required overall duty cycle (D) is fully met, and there is sufficient OFF time on each PWM cycle to allow the transformer cores to fully reset their magnetization.

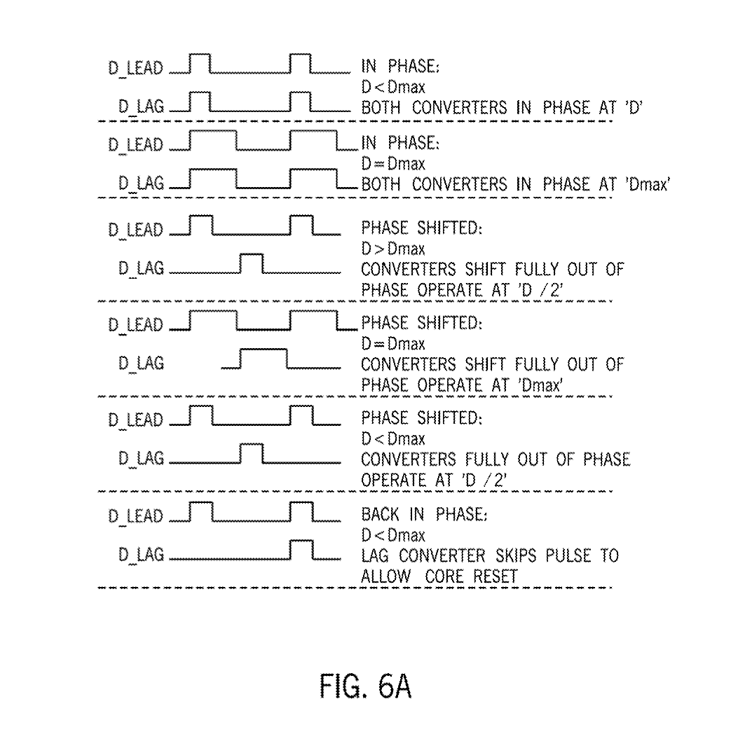

FIG. 6 illustrates a more extreme reduction of phase shift. For this condition the overall duty cycle has been reduced from D to D′, with D′ being less than Dmax, so the two converters can now operate once again in phase. As with the previous situation of FIG. 5, as the phase shift is decreasing the lagging converter maintains the location of its leading edge from the previous cycle and first shifts the location of the trailing edge (shifts to TE′). However, for this situation the new trailing edge actually precedes the location of the previous leading edge (LE_PREV). This effectively means the PWM ON period ends before it begins. This can't happen, so effectively the initial PWM pulse for the lagging converter is missing altogether and the subsequent PWM cycle the lagging converter is fully in phase and matches the duty cycle of the leading converter. As with the previous situation however the overall duty cycle is still fully met as required, and both converters have allowed sufficient time for their respective transformer cores to fully reset. For this particular condition the overall duty cycle was fully met on the initial PWM cycle after the change, by the lead converter alone. On the subsequent cycle the two converters once again operate in phase and share the load current.

For the initial PWM cycle after the overall duty cycle has decreased as shown, there is a mismatch in average current between the leading and lagging converter (for FIG. 6 the lagging converter skipped one PWM cycle). This momentary mismatch in average current is accounted for, particularly for welding conditions where the two converters repeatedly shift out of phase and then back into phase, by alternating which converter is treated as the lagging converter and which is treated as the leading converter. Alternately the overlap time (ie. The trailing edge of the lead converter) is adjusted or modulated to more closely match the overall average current between the two converters. This may be desirable for example in a situation with a series arrangement (stacked DC bus) of the primary side of the two converters (see '293 patent).

As with the '293 patent the requirement to momentarily reduce a pulse width while phase shifting to provide sufficient time for the transformer core to reset is achieved. However, by modulating the leading and trailing edges of the lagging converter as illustrated the overall control duty cycle is always met, and both converters always have sufficient time for the transformer core to full reset.

The equations below define the PWM duty cycle patterns for the two forward converters during phase shifted operation including splitting of the overlap time as desired to more closely match the average currents in the two converters:

If D > Dmax

Dphase = D−Dmax
If Dphase > Dphase {previous} (phase shift is increasing)

Dlead = D/2 {LE = 0, TE =D/2}
Dlag = Dmax {LE = Dphase, TE = D}

If Dphase < Dphase {previous} (phase shift is decreasing)

Dlead = Dprevious/2 {LE = 0, TE =Dprevious/2}
Dlag : {LE = Dphase{previous}, TE = D}

The following equations define the PWM duty cycle patterns for the two forward converters for in phase operation, including as the two converters shift back into phase after operating with a phase shift:

If D < Dmax

Dphase = 0
Dlead = D {LE = 0, TE =D)
Dlag: {LE = Dphase {Previously}: TE= D}
If TE < LE

Dlag = 0: {LE=0, TE =0)

FIG. 6A shows an alternative implementing phase shifting that can also allow the overall duty cycle commanded by the control to be fully satisfied, as well as provide sufficient time on every PWM switching cycle to allow full reset of the transformer cores.

The two forward converters operate in phase with matched duty cycles for values of duty cycle less than or equal to Dmax. Once the overall duty cycle exceeds Dmax, the two converters will shift to operate in a fully phase shifted manner, rather than in an overlap or adjacent manner. As shown, once Dmax is exceeded the lag converter shifts its phase so that it lags the lead converter by one half of the complete PWM switching cycle (ie. 180 degrees out of phase). At the same time both converters now operate at individual PWM duty cycles set to one half of the overall duty cycle (D). For further increases in overall duty cycle (D) each forward converter again continues to increase its individual duty cycle until once again they each operate at Dmax.

As the overall duty cycle decreases, the two converters continue to operate in a phase shifted mode until the overall duty cycle once again falls below Dmax. At that point the lag converter shifts back into phase with the lead converter and each operate with individual PWM duty cycles set to the overall duty cycle (D). The lag converter skips the initial pulse after shifting back into phase with the lead converter to provide a normal full OFF period to allow reset of the magnetization of the transformer core. For the initial in phase cycle the lead converter carries the full load current. On subsequent PWM switching cycles the lead and lag converters operate once again in phase and will share the load current.

Another aspect of this disclosure is full or partial compensation of the duty cycle based on output load current to help linearize the control and/or reduce discontinuities in the control. The method includes full or partial compensation of the duty cycle based on output load current and the controller includes a phase shift module responsive to an output load.

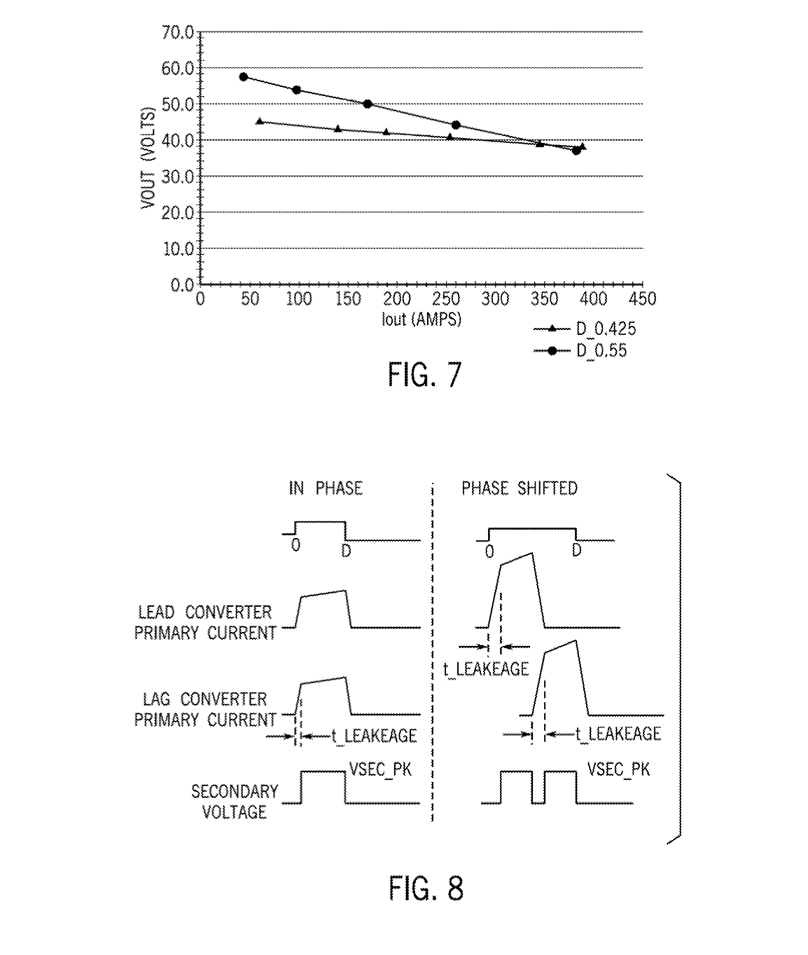

FIG. 7 shows a couple typical load lines illustrating the relationship between power supply output voltage and output current for two different operating duty cycles. The line for D=0.425 represents a condition where the two forward converters are operating in phase and near Dmax. The line for D=0.55 represents a condition where D>Dmax and therefore the two converters operate in a phase shifted manner. It can be seen at higher currents (around 350 Amps) the operation at D=0.55 actually generates less output voltage than the lower duty cycle of D=0.425. This is due to the steeper slope of the typical load line for phase shifted operation vs. in phase operation of the two converters.

The steeper slope for the phase shifted operation is a result of each converter individually carrying the full output current rather that equally sharing the current as they do for in phase operation. This results in greater voltage drop and losses throughout the circuit which subtracts from the voltage supplied to the output of the power supply. One of the main contributors to this is the time it takes to overcome the leakage inductance of the transformer and other parasitic circuit inductances. During the time interval required to ramp the current through the leakage inductance to the operating point, no voltage is applied to the secondary of the transformer and therefore no voltage is applied to the output during this time. This is illustrated in FIG. 8.

For the in phase operation each converter carries 50% of the load current and therefore the time it takes to overcome the leakage inductance (t_LEAKAGE) is approximately ½ of the time it takes for phase shifted operation. The phase shifted operation is further impacted by leakage because there are now two discrete time intervals required to overcome the leakage and both of these events subtract from the voltage that is applied at the secondary of the transformer to the output circuit.

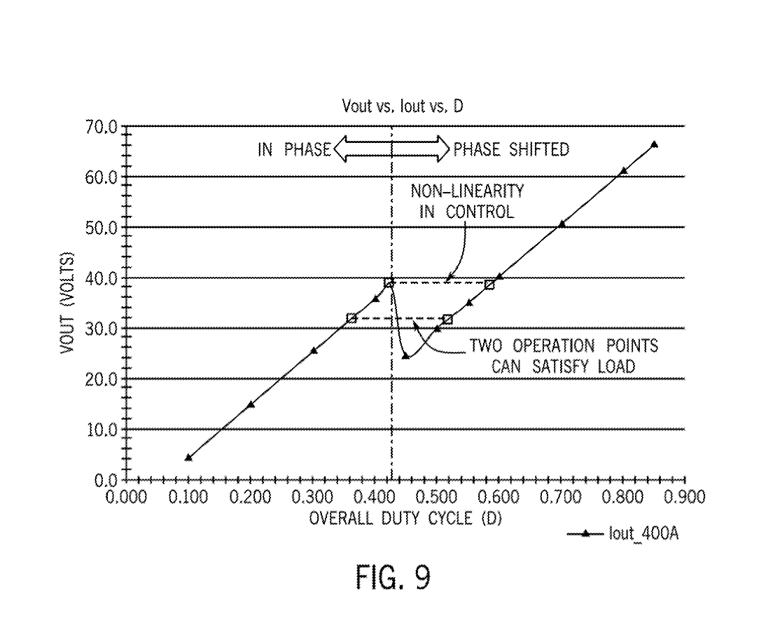

The net result of this behavior is a nonlinearity or disturbance in the load lines as the converters shift out of phase and can or will in fact create a momentary decrease in output voltage rather than the intended increase as the duty cycle is increased into a phase shifted operation. This will require the control to further increase the duty cycle to overcome these additional voltage drops. This non-linear behavior is illustrated in FIG. 9.

It can be seen that at duty cycles greater than approximately 0.45 the two converters begin to shift out of phase. For the particular load condition illustrated (400 Amps) the output voltage will decrease from around 40 Volts to approximately 25 Volts for a slight increase in duty cycle as the converters shift out of phase. In fact, the voltage remains less than the in phase voltage until the duty cycle (D) is increased all the way to nearly 0.600. Further increases in duty cycle beyond 0.600 will have the intended effect of increasing the output voltage as required to meet the dynamic load requirements.

The other issue this causes is as the dynamic load voltage requirement decreases and the duty cycle is reduced the control will eventually satisfy the normal load requirement while still operating in a phase shifted mode, rather than dropping back to the lower in phase duty cycle that can meet the same normal load. This means that the converters can get “caught” operating in a phase shifted mode for a normal load voltage, even though the preferred mode of operation is to operate in phase where the converters operate much more efficiently.

For example, if the normal operating voltage is around 32 Volts as shown, the converters can be caught operating at a duty cycle of around 0.54 rather than 0.35 which is an in phase condition. With the non-linearity shown the output voltage would have to decrease well below the desired normal voltage, and then jump back to almost 40 Volts, until eventually settling at a duty cycle of around 0.35. With a linear control response this non-linear characteristic will not be overcome.

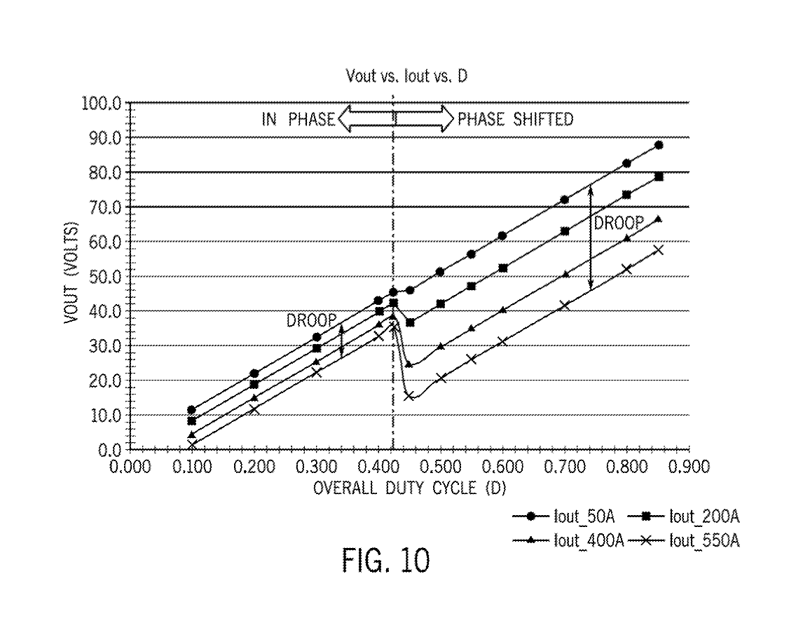

FIG. 10 shows a family of load lines for different output currents (50A, 200A, 400A & 550A). These curves show the relationship between overall duty cycle and average output voltage. The 400A curve is the same curve shown individually in FIG. 9. This family of curves further illustrates the non-linearity in the control as the two forward converters transition from in phase operation to a phase shifted operation (at D 0.45). The family of curves further illustrates the effect of higher load currents and increasing “droop”. The effect of droop for phase shifted vs. in phase is evident by the significant increase in the separation of the parallel load lines for phase shifted operation.

At lower output current levels (ex. 50A), the non-linearity is much less pronounced. In addition, at lower currents it is less likely that the control is caught operating in a phase shifted mode after satisfying a dynamic load but would naturally fall back into an in phase condition. This is because the “normal” or average load voltage is only satisfied by one operating point. A typical “normal” or average load voltage for an arc welding power supply can be defined by the following equation (or a similar equation depending on the specific weld process).

Vout=20V+0.04*Iout

This equation shows that at 50 Amps a normal load voltage is 22V, and around 28V at 200 Amps. FIG. 10 shows a non-linearity in the 50 Amp curve (transition between in phase and phase shifted) at approximately 45V. This voltage is well above the normal or average voltage of 22V, so there is only one condition that will satisfy the normal load voltage of 22V (D 0.2), and that falls within the desirable in phase operation. So it can be seen that at lower current levels the control naturally transitions back into phase after a dynamic load voltage event requiring greater than normal voltage, and the non-linearity is relatively small and may not cause much if any noticeable disturbance in the welding arc.

The present disclosure provides a way to compensate or partially compensate the control response so it reduces or eliminates the non-linearity shown in FIGS. 9 & 10. This can reduce or eliminate any disturbance in the welding arc as the control causes the two converters to shift in or out of phase. It can also reduce or eliminate the chance of getting caught at a phase shifted operating point to satisfy a normal load voltage.

One alternative fully compensates the control to output voltage response for in phase as well as phase shifted operation. Full compensation can make the control response mostly independent of the output current for both in phase and phase shifted operation. Other alternatives partially compensate for phase shifted operation, and/or partially compensate for non-phase shifted operation. The equations below and charts that follow illustrate several options of compensating the duty cycle to output voltage load line characteristic.

The relationship between output voltage and overall duty cycle can be described by the equation below, (including a first order term to represent the droop characteristic).

$${V}_{out} = D * ( {V}_{bus} * \frac{{N}_{s}}{{N}_{p}} ) - ( Droop * {I}_{out} )$$

Vbus and Ns/Np represent the primary DC bus voltage feeding the converter and the transformer turns ratio respectively. Droop is a constant representing the effect of load current on operating voltage. The droop terms for FIG. 7 for example are approximately 2 Volts/100 Amps and 6 Volts/100 Amps for in phase and phase shifted operation respectively.

A compensation term can be added to the duty cycle (D) to account for and fully or partially cancel the droop term.

$${V}_{out} = ( D + {D}_{comp} ) * ( {V}_{bus} * \frac{{N}_{s}}{{N}_{p}} ) - ( Droop * {I}_{out} )$$

$$Therefore \text{:}$$

$${D}_{comp} = \{ Droop * \frac{{N}_{p}}{{V}_{bus} * {N}_{s}} \} * {I}_{out}$$

$$\{ Droop * \frac{{N}_{p}}{{V}_{bus} * {N}_{s}} \} \begin{matrix}is a constant dependant on in phase or \\ phase shifted operation\end{matrix}$$

$${D}_{comp 1} = \{ {Droop}_{1} * \frac{{N}_{p}}{{V}_{bus} * {N}_{s}} \} * {I}_{out} For in phase operation$$

$${D}_{comp 2} = \{ {Droop}_{2} * \frac{{N}_{p}}{{V}_{bus} * {N}_{s}} \} * {I}_{out} For phase shifted operation$$

$${D}_{comp 3} = \{ ( {Droop}_{2} - {Droop}_{1} ) * \frac{{N}_{p}}{{V}_{bus} * {N}_{s}} \} * {I}_{out} \text{:} \begin{matrix}Difference between \\ the two modes\end{matrix}$$

Dcomp3 represents the compensation required to be added to the duty cycle to bring the phase shifted load lines into alignment with the in phase load lines.

To compensate the duty cycle, one or more of the compensation terms can be added based on the mode of operation:

Full compensation all modes:

D′=D+D_{comp1}: If D′>Dₘₐₓ:D′=D′+D_{comp3}

Full compensation phase shifted only:

If D>Dₘₐₓ:D′=D′+D_{comp2}

Partial compensation phase shifted mode only (align phase shifted with in phase load lines):

If D>Dₘₐₓ:D′=D′+D_{comp3}

These various compensation terms can be generated by multiplying the instantaneous output current by a constant, such as a multiple of a feedback signal. Alternatives include using multiples of the current command or duty cycle. Further modifications to the compensation term can be made such as adding an offset, or by using other factors or equations, including terms in a lookup table. The constants or correction factors may be pre-programmed and be based on the pre-determined droop characteristics or other characteristics of the welding power source. Alternately the constants or correction factors can be determined by operating the power source at various duty cycle and load conditions and measuring the output voltage and load current relationship to determine the constants or correction factors. These factors may then be stored in non-volatile memory and used to compensate the relationship between duty cycle and output voltage.

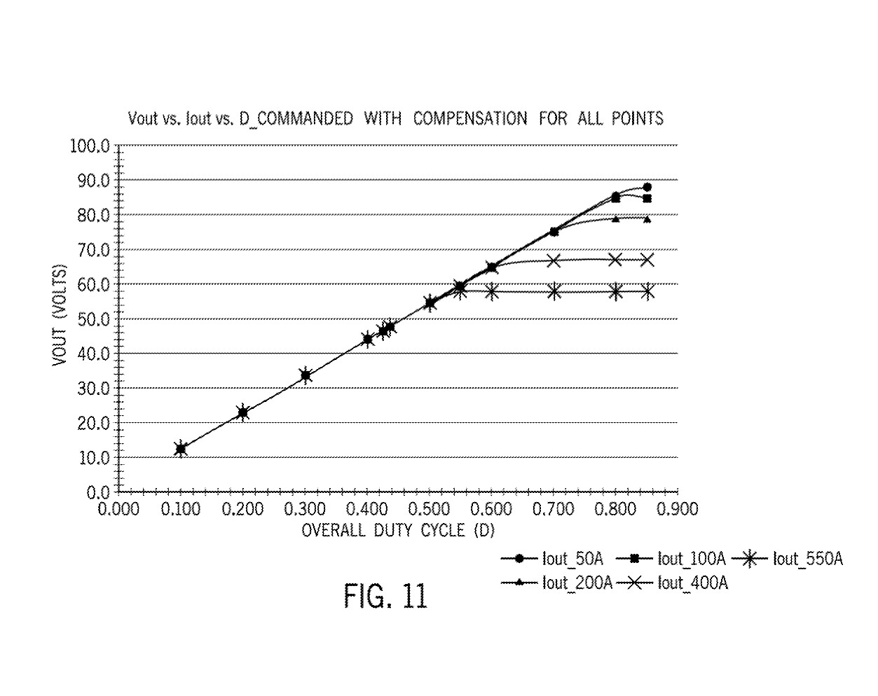

FIG. 11 shows the load line characteristics for several operating current levels, with full compensation. With full compensation the effect of load current is removed such that the predicted output voltage follows a linear relationship vs commanded duty cycle (D). Commanded duty cycle represents the duty cycle the control loop is requesting, prior to the addition of the compensation terms. Each load current curve reaches a point at which no more voltage can be produced (ex. At 550 Amps max voltage is around 58 Volts).

D′=D+Dcomp1: If D′>Dmax: D′=D′+Dcomp3

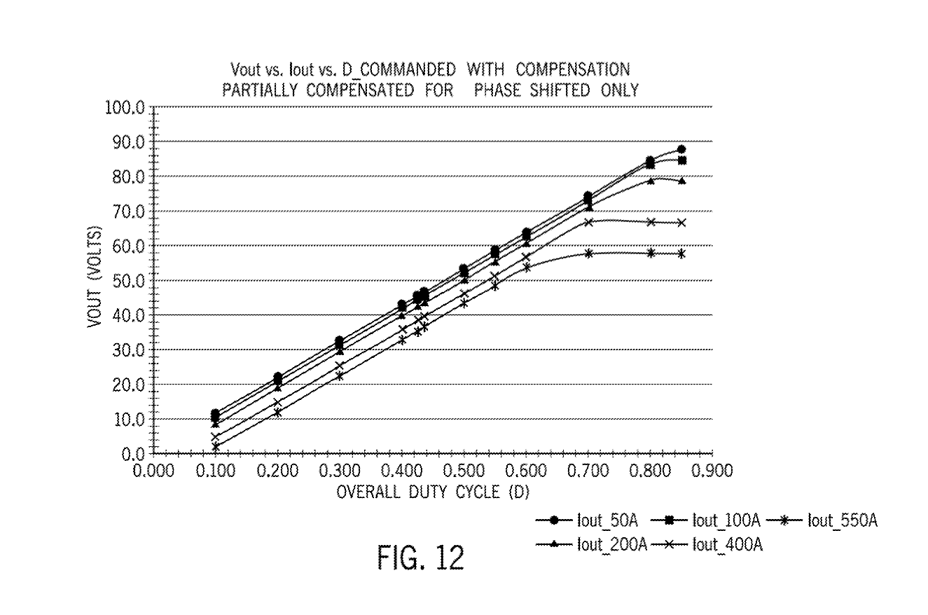

FIG. 12 shows the characteristics for partial compensation where the duty cycle is only compensated during phase shifted operation, and only with sufficient compensation to bring the phase shifted load lines into alignment with the in phase load lines. With the partial compensation shown in FIG. 12 there is still droop that reduces the actual output voltage as the current is increased, however the effective droop is now the same between the two modes of operation. This eliminates the non-linearity in the duty cycle control, as the two forward converters shift out of phase.

If D>Dmax: D′−D′+Dcomp3

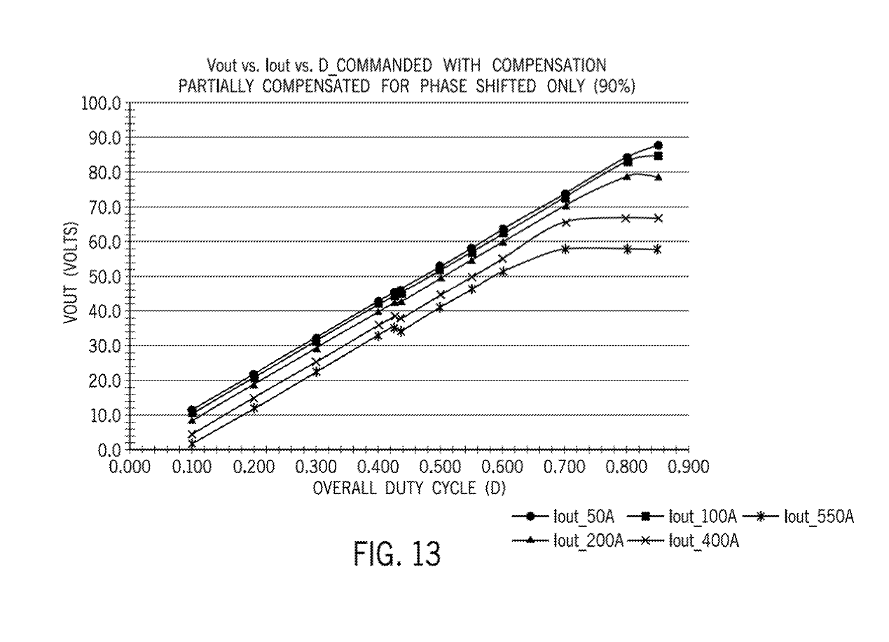

FIG. 13 shows the relationship between output voltage and duty cycle (D) for various load currents where the duty cycle has only been compensated during phase shift mode, and then only by 90% of the calculated correction factor that fully aligns the in phase and phase shifted lines. This characteristic can be beneficial to account for the variation from one power source to the next if pre-determined and pre-programmed compensation constants are utilized. This level of compensation adjusts the load line such that at normal load currents and voltages, in phase operation is guaranteed. In addition, it provides a small amount of “hysteresis” such that once the control transitions back into phase it is less likely to dither back and forth between the two modes of operation.

If D>Dₘₐₓ:D′=D′+0.9*D_{comp3}

As can be seen from the figures there are several ways that duty cycle compensation can be added to reduce or eliminate the non-linearity in the duty cycle control response. The PSDF control may also employ other means such as detailed in the '293 patent to eliminate prolonged operation in phase shifted mode. A timer restricts phase shifted operation to a time limit, in one alternative. The timer can also take into account output current such that at lower currents the timer is disabled or the time limit modified. Phase shifted mode of operation can be restricted based on output current levels at well as weld process selected or the state of the welding arc (ex. short circuit, open circuit, dynamic voltage/current event, etc.).

Another aspect of the disclosure is modification of Dmax based on output load current to provide a wider window of operation for in phase operation. As detailed above and in the '293 patent it is desirable with the PSDF converters to operate the two forward converters in phase if possible and for all normal or average load conditions. As such a decision has to be made at what maximum duty cycle does phase shifting have to start taking place in addition to duty cycle modulation to satisfy the dynamic requirements for the control. It is therefore desirable to set Dmax as high as possible, while still providing sufficient OFF time under all conditions for the forward converter transformers to fully reset. The method provides that Dmax is modified based on output load current to provide a wider window of operation for in phase operation, and the controller includes a Dmax module that sets Dmax and is responsive to output load current to provide a wider window of operation for in phase operation.

Dmax is typically restricted to a value less than the theoretical limit of 50% (ie. 0.5) for a forward converter. (It is possible for a forward converter to exceed 50% duty cycle if some means is provided to increase the transformer core reset voltage above the driving voltage. One means is to place a Zener diode in series with the core reset or clamp diodes—52,54 of FIG. 18.

Typical values for Dmax range from 0.4 to 0.48. Dmax preferably takes into account gate drive delays and voltage rise times of the semiconductor switches to guarantee that under all conditions the transformer core has sufficient time to fully reset.

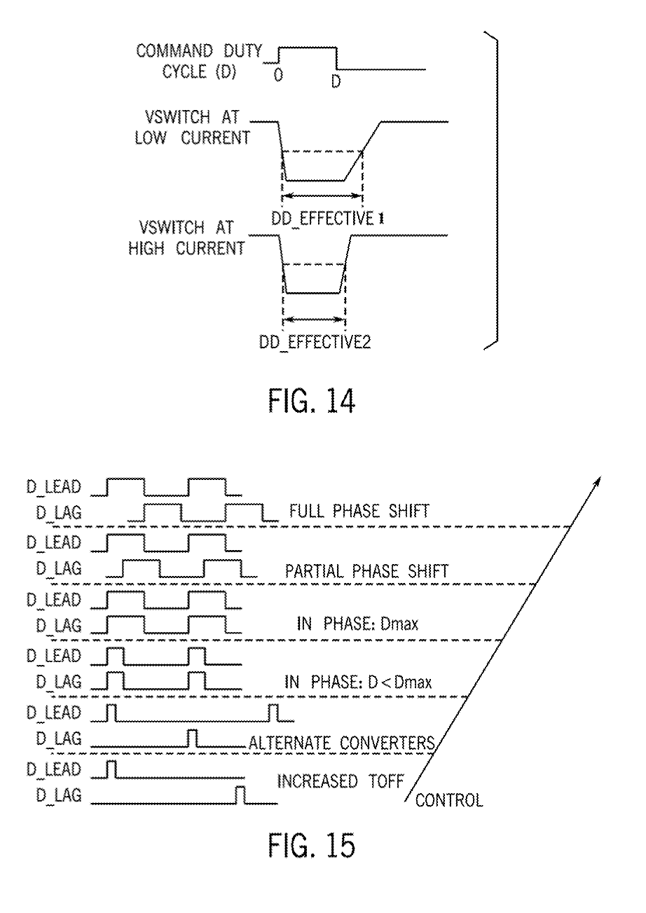

FIG. 14 shows an effective duty cycle. This is representative of the actual voltage applied across the forward converter transformer primary winding vs. the commanded duty cycle called for by the control. In some cases the effective duty cycle may be greater than what the control is commanding, in other cases it may be less. Factors such as gate drive delays and voltage rise time on the semiconductor switch (Mosfet, IGBT, etc.) as mentioned above can impact the effective duty cycle. Two different effective duty cycles are shown above (D_effective1, D_effective2) for two different load current conditions. This shows that the load current can have an impact on the effective duty cycle.

It may be necessary to set a lower Dmax limit for low current based on a higher D_effective1. Using a single value for Dmax may require a lower value than would otherwise be required at higher currents (with D_effective2 for example more closely matching D). This would force the PSDF control to transition to phase shift mode at a lower duty cycle than would otherwise be necessary at higher load currents. Due to the desire to provide as wide of range or operation for in phase operation of the forward converters as possible, it can be beneficial to adjust Dmax based upon the output load current.

One or more values may be used for Dmax, for example Dmax=0.4 for output current less than 100 Amps, and Dmax=0.45 for output current greater than 100 Amps. Alternately a range of Dmax or relationship with output current may be established and employed to adjust Dmax. The adjustment of Dmax for output load current may be implemented for in phase operation, and fixed for phase shift operation.

Another aspect of the disclosure is extended operating range for low current/voltage by reducing pulse skipping. The method includes disabling either the lead or lag converter. The controller includes a pwm module (the phase shift module is part of the pwm module), and the pwm module includes a disabling module responsive to the output current and/or output voltage and disables one of the converters.

FIG. 15 details how the control can extend operation for low voltage and low current operation to provide more consistent PWM switching events. (See previous summary). This figure shows a full range of control. The control signal may be generated via an analog control circuit such as a closed loop current or voltage regulator, or it may be generated digitally by sampling various analog inputs and calculating a required control output. The control output can be utilized to control several aspects of the operation of the PSDF welding power supply.

At low values of the control signal or control variable the OFF time of the two forward converters may be controlled via a linear or non-linear relationship to the control. As the control increases the two converters may reach a point of minimum OFF time (ie the normal OFF time or switching period), further increases may cause the two converters to alternate their operation as detailed in the summary to allow more consistent PWM pulse width generation to occur. For this level of control signal the PWM pulse width of the alternating converters may be a function of the control signal or variable. The alternating behavior of the converters may be disabled based on an output current threshold and the two converters operate in phase with a common PWM duty cycle.

Additional signals or inputs may be used to modify or influence the control behavior whereby the two converters alternately supply the load and/or the OFF time is increased. One of these inputs may include user inputs such as the weld process selected (ex. GTAW or TIG), or preset current level. Some weld processes such as GTAW operate at lower voltage than other processes and may benefit by forcing the converters to operate in an alternating manner and thus individually operate at a greater control duty cycle and provide more consistent PWM switching waveforms.

Further increases in the control will further increase the PWM duty cycles of the two in phase converters until Dmax is reached. A further increase in the control will cause the two converters to begin to shift out of phase and operate in a phase shifted more of operation, until a maximum control output is reached resulting in maximum phase shift and the maximum output voltage that the two converters can produce.

Numerous modifications may be made to the present disclosure which still fall within the intended scope hereof. Thus, it should be apparent that there has been provided a method and apparatus for providing welding type power that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims.

1. A method of providing welding type power comprising:
receiving input power;
pulse width modulating a first forward converter and a second forward converter, such that they operate as a pulse width modulated double forward converter to provide a welding type output;
phase shifting an output of the second forward converter relative to an output of the first forward converter when at least one of a duty cycle, a current command and the welding type output exceeds a threshold, wherein a leading edge of the second forward converter is adjusted and a trailing edge of the second forward converter is adjusted to provide the phase shifting; and
operating the first forward converter and the second forward converter in phase when at least one of the duty cycle, the current command and the welding type output is in a given range.

2. The method of claim 1, further comprising phase shifting the output of the second forward converter relative to an output of the first forward converter when at least one of a duty cycle, a current command and the welding type output is less than a second threshold.

3. The method of claim 1, further comprising phase shifting the output of the second forward converter relative to an output of the first forward converter when at least one of a duty cycle, a current command and the welding type output is less than a second threshold and the welding type output is used for stick welding.

4. The method of claim 1, wherein phase shifting an output of the second forward converter relative to an output of the first forward converter further comprises adjusting a trailing edge of the first forward converter.

5. The method of claim 4, wherein adjusting a trailing edge of the first forward converter is done in response to a difference between an average current of the first forward converter and an average current of the second forward converter.

6. The method of claim 1, further comprising phase shifting an output of the first forward converter relative to an output of the second forward converter when at least one of a duty cycle, a current command and the welding type output exceeds a threshold, wherein a leading edge of the first converter is adjusted and a trailing edge of the first forward converter is adjusted to provide the phase shifting of the output of the first forward converter, wherein phase shifting an output of the first forward converter and phase shifting an output of the second forward converter are alternately performed.

7. The method of claim 1, wherein phase shifting an output of the second forward converter provides sufficient time for the transformer core to reset.

8. The method of claim 1, wherein the phase shifting an output of the second forward converter is responsive to an output load current.

9. The method of claim 8, wherein phase shifting an output of the second forward converter responsive to the output load current is performed such that at least one of a control without discontinuities and a linear control is provided.

10. The method of claim 1, wherein the pulse width modulating includes adjusting the duty cycle by an offset that is a function of at least one of the duty cycle, the current command and the welding type output.

11. The method of claim 10, wherein the function of at least one of the duty cycle, the current command and the welding type output is at least one of:
a multiple of the duty cycle;
a multiple of the current command;
a multiple of the welding type output;
a value in a look up table;
responsive to a time limit;
responsive to a selected weld process; and
responsive to a state of the welding arc.

12. The method of claim 8, wherein the phase shifting an output of the second forward converter further comprises adjusting the threshold in response to at least one of the duty cycle, the current command and the welding type output, wherein when at least one of the duty cycle, the current command and the welding type output exceeds the adjusted threshold the phase shifting an output of the second forward converter is performed.

13. The method of claim 12, wherein the adjusted threshold is adjusted between at least one of: two discreet values; more than two discreet values; a range of values; and more than one range of values.

14. The method of claim 12, wherein the adjusted threshold is responsive to whether or not the first forward converter and the second forward converter are in phase or out of phase.

15. The method of claim 12, wherein adjusting the threshold provides a duty cycle of more than 50%.

16. The method of claim 1, further comprising disabling the first forward converter and enabling the second forward converter when at least one of the duty cycle, the current command and the welding type output is less than a third threshold.

17. The method of claim 1, further comprising alternately disabling the first forward converter and enabling the second forward converter, and then enabling the first forward converter and disabling the second forward converter, when at least one of the duty cycle, the current command and the welding type output is less than a third threshold, and in response to sensing a first bus voltage and sensing a second bus voltage.

18. A welding type power supply, comprising:
a phase shifted double forward converter having a first and second converter; and
a controller, where the controller includes a pwm module that sets the pwm timing signals, and wherein the pwm module includes a phase shift module that has a leading edge adjusted output and a trailing edge adjusted output, and wherein the phase shift module is responsive to an output load.

19. The welding-type power supply of claim 18, wherein the phase shift module includes at least one of a duty cycle offset module and a Dmax module that sets Dmax that is responsive to output load current.

20. The welding-type power supply of claim 19, wherein the phase shift module includes a disabling module responsive to at least one of the output current and output voltage and disables one of the first and second converters.
